(19) United States
(12) Patent Application Publication
(10) Pub. No.: US 2005/0220679 A1
(43) Pub. Date: Oct. 6, 2005

(54) System for automobile exhaust gas purification

(76) Inventor: Sung-Mu Choi, Sungnam (KR)

Correspondence Address: MORGAN, LEWIS & BOCKIUS LLP (SF), 2 PALO ALTO SQUARE, PALO ALTO, CA, 94306, US

(21) Appl. No.: 11/022,238

(22) Filed: Dec. 23, 2004

(30) Foreign Application Priority Data
Apr. 6, 2004 (KR) 2004-0023423

(51) Int. Cl. B01D 53/34; F01N 3/28

(52) U.S. Cl. 422/177; 422/180; 422/171

(57) ABSTRACT

The present invention relates to a system for purifying automobile exhaust gas capable of allowing an absorption catalyst to purify exhaust gases, where the exhaust gases flow through the absorption catalyst in a CCC at the inital start time of the engine and capable of allowing a UCC catalyst to purify exhaust gases normally by flowing the exhaust gases only through the UCC catalyst by disconnecting a flow path connected with the absorption catalyst in the CCC during a warm-up state of the UCC catalyst. The CCC is installed near an engine exhaust manifold, and a UCC is installed in a lower side of the automobile body floor. A HC absorption catalyst and a NOₓ absorption catalyst each having little or no precious metal carrying amount, are installed in the CCC. A variable flow path system, including a bypass flow path and a flow path switching part, is provided.

### CROSS-REFERENCE TO RELATED APPLICATIONS

This application claims priority from Korean Application No. 10-2004-0023423, filed on Apr. 6, 2004, which is incorporated fully herein by reference.

### FIELD OF THE INVENTION

The present invention relates to a system for purifying automobile exhaust and, in particular, to a system for purifying automobile exhaust gas of with a variable flow path system that includes a bypass flow path and a flow path switching means, wherein a Close Catalyst Converter (CCC) is installed near an engine exhaust manifold and a Underfloor Catalyst Converter (UCC) is installed in a lower side of an automobile body floor. A hydrocarbon (HC) absorption catalyst, and a NOₓ absorption catalyst each having little or no precious metal, are provided in the CCC.

### BACKGROUND OF THE INVENTION

Generally, automobile exhaust gas is a gas generated by combustion of a fuel mixture and discharged into the air through an exhaust pipe. The exhaust gas has a lot of harmful gases, such as CO, NOₓ, HC, etc. These days, preventing atmosphere pollution from automobile exhaust has become an important concern. Therefore, through regulations, exhaust gases should be purified before being discharged.

A catalyst converter using a three-way catalyst is generally used to purify automobile exhaust gases. The catalyst converter is installed at an intermediate portion of the exhaust pipe, and the specifications for the catalysts vary because the exhaust gas emission amount varies according to automobile models.

Here, the three-way catalyst represents a catalyst that is concurrently reacted with CO, NOₓ and HC, which are the harmful components of the exhaust gas, and removes the above compounds. Mainly, a Pt/Rh, Pd/Rh or Pt/Pd/Rh group is used as a three-way catalyst.

In the case of a gasoline-driven automobile, a catalyst converter installed in a lower side of an automobile body floor, namely, Underfloor Catalyst Converter (UCC) is used as an after-treatment apparatus for the exhaust gas. The trend is to increase the volume of the catalyst in order to enhance the purification ratio. Since the height of an automobile body is low, an oval or racetrack-shaped catalyst has been generally used, wherein a horizontal cross section is extended in both directions.

Generally, a gasoline-driven automobile exhaust gas purification system minimizes the amount of harmful components discharged when the engine first starts. Upon starting the engine, the exhaust gas passes through the catalyst, but the catalyst does not remain in a full warm-up state. Since the temperature of the catalysts is not high enough to render the harmful components of the exhaust gas harmless, there exists a need to quickly increase the temperature of the catalyst in order to minimize the amount of harmful components being discharged when starting the engine.

In particular, two-thirds of HC and NOₓ are discharged when the catalyst is not fully warmed up at the initial start time of engine. Thus, decreasing HC and NOₓ during the engine's start up becomes an important concern of the highest priority in decreasing exhaust gas emission levels.

To address this issue, the catalyst converter may be installed near the exhaust manifold of the engine in the Close Catalyst Converter (CCC), where the catalyst is warmed up.

In another method, the warm-up time of the catalyst is decreased by increasing the carrying amount of a precious metal in the catalyst of the CCC or in a catalyst thin wall carrier or metal carrier. To decrease heat loss, a duplicated pipe or a duplicated exhaust manifold has been adapted.

However, the conventional exhaust gas purification system has the following problems. First, in the case when the catalyst is positioned near the engine like the CCC, the durability and heat resistance are largely negatively affected. In the case of Electrically Heated Catalyst (EHC) or Burner Heated Catalyst (BHC), an excessive electrical capacity (battery or alternator) is needed. A particular fuel is also needed for heating the catalyst. In this case, critical thermal damage may occur in the catalyst due to the applied heat. In addition, in the case when the carrying amount of a precious metal of the catalyst is increased, the manufacturing cost of the catalyst increases because the use of an expensive precious metal has increased.

### SUMMARY OF THE INVENTION

Embodiments of the present invention provide a system for purifying automobile exhaust gases that overcome the problems encountered in the art.

The present invention provides a system to purify automobile exhaust gases capable of allowing an absorption catalyst to purify exhaust gases, where the exhaust gases flow through the absorption catalyst in a CCC at the initial start time of the engine and, afterward, a UCC catalyst to purify exhaust gases normally by flowing the exhaust gas only through the UCC catalyst by disconnecting a flow path connected with the absorption catalyst in the CCC during a warm-up state of the UCC catalyst. A HC absorption catalyst and a NOₓ absorption catalyst, each having little or no precious metal, are installed in the CCC. A variable flow path system, including a bypass flow path and a flow path switching means, is provided. Therefore, the present invention enhances the purification performance sufficiently, and decreases the manufacturing cost by using a HC absorption catalyst and a NOₓ absorption catalyst that use little or no precious metals in the CCC. In addition, since the CCC catalyst is used for a short period of time by using a variable flow path, heat resistance and durability of the CCC catalyst are improved.

### BRIEF DESCRIPTION OF THE DRAWINGS

The aforementioned aspects and other features of the present invention will be explained in the following description, taken in conjunction with the accompanying drawings, wherein:

FIGS. 1a and 1b are cross-sectional views illustrating a structure for a an exhaust gas purification system and an operation state of the same according to the present invention;

FIGS. 2a, 2b, 3a, and 3b are cross-sectional views illustrating a flow path of an opening and closing state of a CCC entrance path based on a rotation position of a ball valve according to the present invention;

FIGS. 4a and 4b are perspective views illustrating an opening and closing state of an intermediate pipe flow path based on a rotation position of a ball valve according to the present invention;

FIG. 5 is a graph illustrating a detaching characteristic based on a temperature variation of a zeolite HC absorption catalyst and a potassium NOₓ absorption catalyst;

FIG. 6 is a graph of a catalyst activation (purification ratio) based on a temperature increase of a typical UCC catalyst; and

FIGS. 7a and 7b are graphs of a result illustrating a purification performance evaluation between a variable flow path type exhaust gas purification system according to the present invention and an exhaust gas purification system of a conventional “CCC+UCC” method.

### DETAILED DESCRIPTION OF PREFERRED EMBODIMENTS

The preferred embodiments of the present invention will be described with reference to the accompanying drawings.

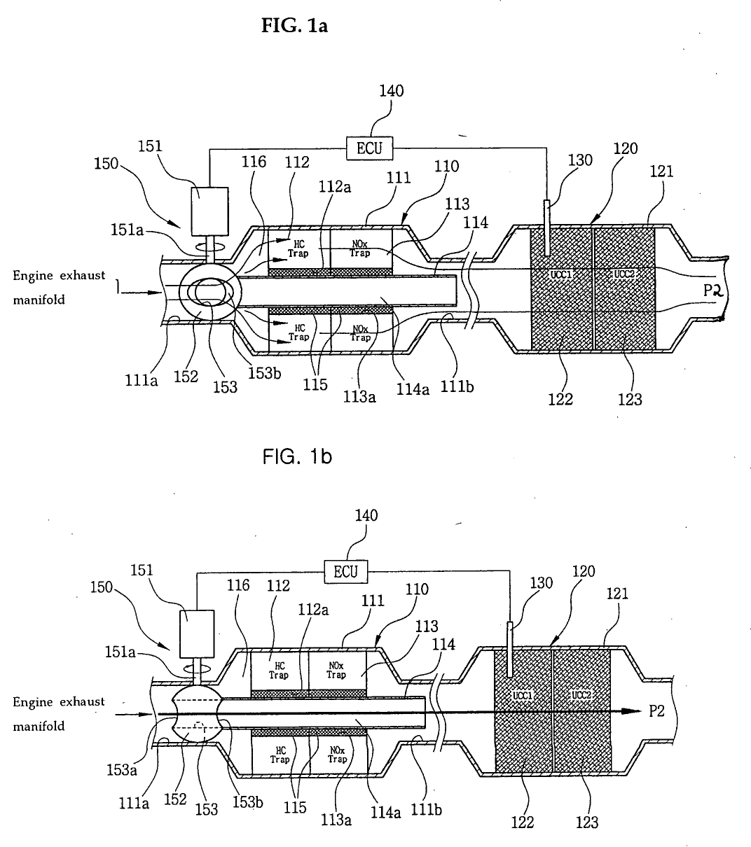

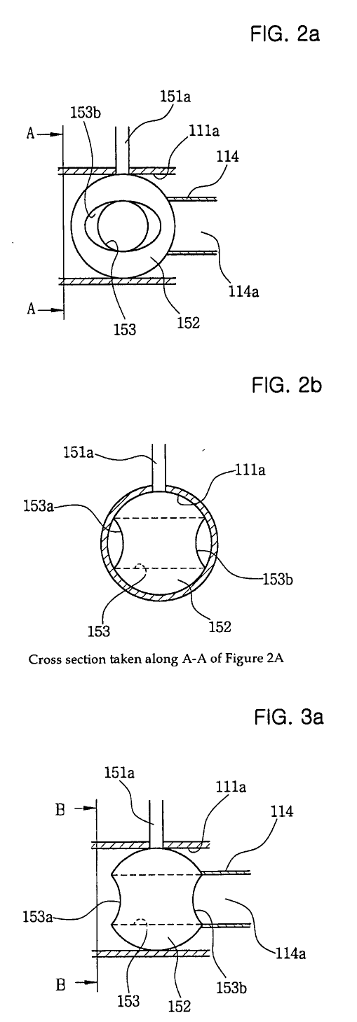

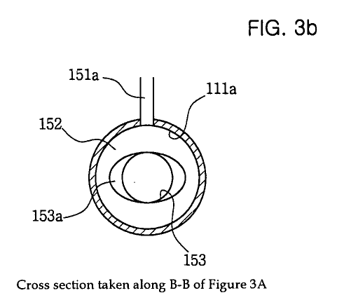

FIGS. 1a and 1b are cross-sectional views illustrating structure for an exhaust gas purification system and an operation state of the same according to the present invention, and FIGS. 2a, 2b, 3a, and 3b are cross-sectional views illustrating a flow path of an opening and closing state of a CCC entrance path based on a rotation position of a ball valve according to the present invention.

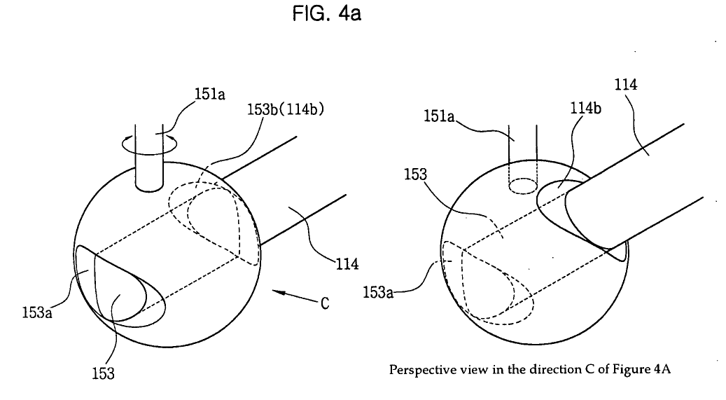

FIGS. 4a and 4b are perspective views illustrating an opening and closing state of an intermediate pipe flow path based on a rotation position of a ball valve according to the present invention.

As shown therein, a CCC 110 and a UCC 120 are installed in series along an exhaust path extended through a rear end of an automobile body wherein exhaust gases from an engine's exhaust manifold flow through the above path before they are discharged into the air. The CCC 110 is installed near the exhaust manifold along the exhaust path, and the UCC 120 is installed at an intermediate portion of the exhaust pipe located in a lower side of the automobile body floor. In the case where the UCC is installed near an exhaust manifold, the UCC 120 may also be referred to as a second CCC. The UCC 120 may also be installed in an orientation that is perpendicular to the CCC 110.

The HC absorption catalyst 112 and the NOₓ absorption catalyst 113 are installed in series in the housing of the CCC. The HC absorption catalyst 112 positioned at the front side can be a zeolite catalyst and has a very low Al/Si ratio and high heat resistance. The NOₓ absorption catalyst 113 of the rear side can be a potassium-based catalyst.

In addition, an intermediate pipe 114 is a type of bypass and is installed at the center of each absorption catalyst 112, 113, so that the exhaust gases entering through the CCC inlet path 11a are discharged through the CCC outlet path 111b not through the two absorption catalysts 112, 113.

The intermediate pipe 114 is longitudinally inserted through central holes 112a, 113a of the two absorption catalysts 112, 113 in the CCC 110. It provides a flow path, in which the inlet and outlet are formed at the front and rear sides of the CCC absorption catalysts 112, 113 and, in detail, in the inlet path 1a and the outlet path 111b of the CCC housing 111, passing through the interior of the CCC housing 111. In particular, the exhaust gases flowing through the interior of the intermediate pipe 114 is discharged to the rear side of the CCC 110, not through the HC absorption catalyst 112 and the NOₓ absorption catalyst 113 in the CCC, and flows through the UCC 120.

In addition, an insulator 115 is installed between an inner surface of the center holes 112a, 113a of the two absorption catalysts 112, 113 and an outer surface of the intermediate pipe 114.

In the UCC 120, two catalysts, namely, a first catalyst 122 and a second catalyst 124, are arranged in series in the interior of the housing 121 like in the conventional art, and a temperature detection sensor 130 is installed at the first catalyst 122. Furthermore, the first catalyst 122 and second catalyst 124 may be the same type used in the CCC 110, such as HC absorption or zeolite catalysts and NOₓ absorption or potassium-based catalysts.

The temperature detection sensor 130 detects the temperature of the first catalyst 122, and outputs an electrical signal corresponding thereto. Namely, it is a means for detecting the warm-up state of the UCC catalyst.

The temperature detection sensor may be a thermocouple. An insertion space is additionally provided in a carrier of the first catalyst 122. The thermocouple is longitudinally inserted into the insertion space.

The automobile exhaust gas purification system further provides a flow path switch means 150 for switching the flow of the exhaust gas between two flow paths divided by the intermediate pipe 114 in the interior of the housing 111 of the CCC, namely, between the inner flow path 114a of the inner side of the intermediate pipe 114 and the outer flow path 116 of the outer side of the intermediate pipe 114. The flow path switching means 150 is controlled by an engine control unit 140 that receives an output signal from the temperature detection sensor 130 in the UCC 120 and determines the warm-up state of the UCC catalyst 122.

The flow path switching means 150 includes a motor 151, controlled in accordance with a control signal from the Electronic Control Unit (ECU) 140, and a valve 152 that switches the flow of the exhaust gas between two flow paths 114a, 116 by the driving of the motor 151.

In an embodiment of the present invention, the valve 152 may be a ball valve fixedly installed at the front end of a rotary shaft 151a of the motor 150. The flow path switching means 150 having the ball valve 152 will be described in detail as follows:

The motor 151 is installed at a particular portion near the CCC housing 111 or the automobile body in the outer side of the CCC inlet path 111a. The ball valve 152 is installed in the interior of the CCC inlet path 111a.

At this time, the ball valve 152, substantially having the same diameter as the inner diameter of the CCC inlet path 111a, can be used. The ball valve 152 is installed at the entrance of the front end of the intermediate pipe 114 where the CCC inlet path 111a is blocked.

In addition, the front end of the rotary shaft 151a of the motor 151 is connected with an upper center part of the ball valve 152. As the rotary shaft 151a of the motor 151 is rotated, the ball valve 152 is rotated.

A gas flow path 153 passes through the center of the ball valve 152. Concave parts 153a, 153b are provided where both ends of the gas flow path 153 would flow. The concave parts 153a and 153b and gas flow path 153 form an exhaust gas flow path with respect to the inner surface of the CCC inlet path 111a at both sides of the ball valve 152 such that of the ball valve 152 is positioned where the gas flow path 153 and the intermediate pipe 114 are arranged horizontally.

As for the flow path switching means 150, the switching of the flow path is achieved based by rotating the ball valve's 152 position. The motor 151 is driven in accordance with a control signal from the ECU 140, and the ball valve 152 is rotated by 0° or 90° with the rotary shaft 151a, so that the flow paths 114a, 116 are switched. The flow paths may be preferably switched at 0° through 360°.

When the ball valve 152 is at the 0° position (initial start time of the engine), the inner flow path 114a of the intermediate pipe 114 is blocked by the ball valve 152, and the outer flow path 116 of the intermediate pipe 114 is opened. As shown in FIGS. 2a and 2b, the gas flow path 153 of the ball valve 152 is arranged in a radial direction with respect to the intermediate pipe 114.

The front inlet of the intermediate pipe 114 is blocked by the ball valve 152, and a flow path is formed between the inner surface of the CCC inlet flow path 111a and the ball valve 152 by the concave parts 153a, 153b at both ends of the gas flow path 153, so that exhaust gases flow through the path.

In addition, a flow path may be formed between the inner surface of the CCC inlet path and the gas flow path when the intermediate pipe 114 and the gas flow path 113 are arranged in a radial direction based on the shape and size of the gas flow path without the concave parts 153a, 153b. The exhaust gas passing through the above flow path sequentially passes through the HC absorption catalyst 112 and the NOₓ absorption catalyst 113 outside the intermediate pipe 114, is discharged through the CCC outlet path 111b, and flows to the UCC 120 through the exhaust pipe.

When the ball valve 152 is rotated by the motor at 90° (warm-up state of the UCC catalyst), the outer flow path 116 of the intermediate pipe 114 is blocked by the ball valve 152, and the inner flow path 114a of the intermediate pipe 114 is opened. As shown in FIGS. 3a and 3b, the gas flow path 153 of the ball valve 152 travels in the same direction as the intermediate pipe 114. The front inlet of the intermediate pipe 114 is opened by the ball valve 152, and the gas flow path 153 of the ball valve 152 is connected with the inner flow path 114a of the intermediate pipe 114. The exhaust gas inputted through the CCC inlet flow path 111a sequentially passes through the gas flow path 153 of the ball valve 152 and the inner flow path 114a of the intermediate pipe 114, is discharged to exhaust pipe through the CCC outlet path 111b, and flows to the UCC 120.

When the ball valve 152 is positioned at the rotation position of 90°, the outer flow path 116 of the intermediate pipe 114 is blocked, and the exhaust gas inputted through the CCC inlet path 111a is directly moved to the UCC 120 without passing through the HC absorption catalyst 112 and the NOₓ absorption catalyst 113. In another embodiment of the present invention, it is possible to set the system as follows. Namely, when the position of the ball valve is at 0°, the gas flow path 153 and the inner flow path of the intermediate pipe 114 may be connected. When the position of the ball valve is at 90°, the inner flow path of the intermediate pipe 114 may be blocked by the ball valve 152, and the outer flow path 116 of the intermediate pipe 114 may be opened.

As shown in FIGS. 4a and 4b, the switching operation of the exhaust gas flow path will be described. When the gas flow path 153 of the ball valve 152 is positioned radially with respect to the intermediate pipe 114 (0° position of ball valve), the exhaust gas flows in the direction of the outer flow path 116 of the intermediate pipe through the concave parts 153a, 153b of both ends of the gas flow path 153 as shown in FIG. 4b. When the ball valve 152 is rotated 90°, and the gas flow path 153 is arranged in the same direction as the intermediate pipe 114, the exhaust gas flows through the gas flow path 153 and the inner flow path 114a of the intermediate pipe.

In FIGS. 4a and 4b, reference numeral 114b is a wing part formed on both sides of the inlet of the front end of the intermediate pipe 114, wherein the wing part 114b is designed to fully cover the concave part 153b in the direction of the rear end of the gas flow path 153.

Namely, the concave parts 153a, 153b of the ball valve 152 are wide in the lateral directions. The wing part 114b fully covers the concave part 153b of the rear end of the ball valve 152, so that the exhaust gas would pass through the gas flows through the intermediate pipe 114 without leakage.

In addition, when the ball valve 152 is rotated, the surface of the ball valve 152 slides such that its surface contacts the front surface of the wing part 114b of the intermediate pipe 114, so that the exhaust gas does not leak. Therefore, the wing part 114b has the same surface curvature as the surface curvature of the ball valve 152.

The operation of the automobile exhaust gas purification system of the present invention will be described as follows.

A variable flow path is adapted for the automobile exhaust gas purification system at the inital start time of engine, the exhaust gas flows through the HC absorption catalyst 112 and the NOₓ absorption catalyst 113 in the CCC 10 to purify the exhaust gas.

When the catalysts 122, 123 of the UCC 120 are at a full warm-up state (for example, the catalyst temperature is over 200° C.), the flow path 116 connected with the HC absorption catalyst 112 and the NOₓ absorption catalyst 113 becomes blocked, namely, the exhaust gas flows only through the catalysts in the UCC 120, so that the UCC 120 purifies the exhaust gases normally.

When the engine starts, exhaust gases are discharged from the engine. The ball valve 152 is positioned like the positions shown in FIGS. 2a, 2b and 4b. The flow path of the exhaust gas, namely, the inner flow path 114a of the intermediate pipe 114 is blocked by the ball valve 152 at the inlet of the front end of the inner flow path 114a of the intermediate pipe 114, and the two flow paths of the concave parts 153a, 153b or left and right sides of the ball valve 152 are opened.

The exhaust gas passes from the flow paths flows through the outer flow path 116 of the intermediate pipe in the CCC 110, sequentially passes through the HC absorption catalyst 112 and the NOₓ absorption catalyst 113, is discharged to the exhaust pipe through the CCC outlet path 111b as shown in FIG. 1a as indicated by arrow P1. Here, HC and NOₓ contained in the exhaust gas components are absorbed by the HC and NOₓ absorption catalysts when the exhaust gas passes through them 112, 113. The exhaust gas, from which HC and NOₓ are removed, flows to the UCC 120.

As the exhaust gas flows in the above-described manner, the temperatures of the first and second catalysts 122, 123 in the UCC are increased. The HC absorption catalyst 112 and the NOₓ absorption catalyst 113 in the CCC 110 continuously absorb the HC and NOₓ until the temperatures of the catalysts 122, 123 have reached their activation temperature (i.e. 200° C.). The harmful gas flows toward the tail pipe, so that the harmful gas is not discharged into the air.

When the temperature of the catalyst in the UCC 120 is continuously increased, and a full warm-up state is achieved based upon reaching the activation temperature, the ECU 140 outputs a motor control signal for rotating the ball valve 152 to an almost 90° position.

The ECU 140 receives a signal from the temperature detection sensor 130 installed in the first catalyst 122 of the UCC 120 and determines whether the catalyst temperature exceeds a predetermined activation temperature that helps determine whether the catalyst is at its warm-up state. When the catalyst 122 is at the warm-up state, the outer flow path of the intermediate pipe (flow path 116 forward of the HC absorption catalyst and NOₓ absorption catalyst in the CCC housing) is blocked. In addition, the ECU 140 outputs a control signal to open the inner flow path 114a of the intermediate pipe 114. Namely, the ECU 140 outputs a motor control signal to rotate the ball valve 152 to an almost 90° position.

When the ball valve 152 is rotated to an almost 90° position, the ball valve becomes positioned in a manner shown in FIGS. 3a, 3b and 4a. In this position, the outer flow path 116 of the intermediate pipe 114 becomes blocked by the ball valve 152, and the inner flow path 114a of the intermediate pipe 114 becomes connected with the gas flow path 153 of the ball valve 152.

In the above position, the exhaust gas passes through the gas flow path 153 of the ball valve 152 and the inner flow path 114a of the intermediate pipe 114 and flows into the UCC through the exhaust pipe, not through the two absorption catalysts 112, 113 of the CCC 110. This flow path is shown as the arrow P2 in FIG. 1b. The exhaust gas is purified by the normally warmed-up catalysts 122, 123 of the UCC 120.

Additionally the HC and NOₓ absorbed by the HC and NOₓ absorption catalysts 112,113 at the initial start time of the engine are naturally detached from the HC and NOₓ absorption catalysts 112, 113 by the heat of the exhaust gas passing through the inner flow path 114a of the intermediate pipe 114 and flow to the UCC 120 through the backwardly opened flow path and are purified by the first and second catalysts 122, 123. In the present invention, the HC and NOₓ absorption catalysts 112, 113 use little or no precious metals in the CCC 110. These absorption catalysts 112, 113 are used in lieu of the conventional CCC catalyst having a high precious metal carrying amount for decreasing the warming time, thereby providing some advantages in terms of manufacturing cost.

Even when the HC and NOₓ absorption catalysts 112, 113 are a bit weak under high temperature and are applied to the variable flow path as the CCC catalysts, because the catalysts are used for a short time period at the initial start time of engine operation, the HC and NOₓ absorption catalysts do not cause any durability and heat-resistance problems. Since the UCC catalysts 122, 123 are the main catalysts that are positioned in the rearward portions, non-toxic and heat-resistance properties are obtained, and it is possible to satisfy the regulations for exhaust gas emissions by using only the UCC 120, which decreases the manufacturing cost.

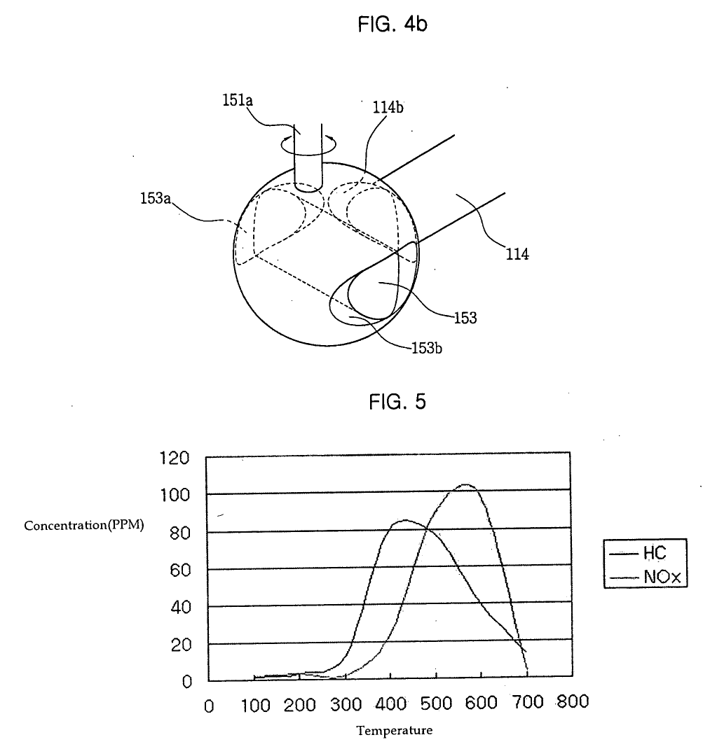

FIG. 5 is a graph illustrating a desorbing characteristic based on the changes in the temperatures of the zeolite HC absorption catalyst and potassium NOₓ absorption catalyst. As shown therein, a graph shows the concentrations of the HC and NOₓ that are desorbed as the temperature increases after the HC and NOₓ absorption catalysts absorb the HC and NOₓ of a given concentration.

After each catalyst absorbs the HC and NOₓ (here, absorption degree depends on the volume of each absorption catalyst), the temperature increases. Thereafter, the HC and NOₓ are desorbed as shown in the graph of FIG. 5. The HC and NOₓ are gradually desorbed at a temperature over 300° C.

In the present invention, it is necessary to delay the desorption of HC and NOₓ from each absorption catalysts 112, 113 in the CCC 110 until the temperatures of the UCC catalysts 122, 123 are fully increased with the inner flow path 114a of the intermediate pipe 114 being opened after the UCC catalysts 122, 123 has warmed up.

In order to delay desorption, an insulator 115 is installed between the outer surface of the intermediate pipe 114 and the inner surfaces of a plurality of holes 112a, 113a of each absorption catalyst 112, 113.

Here, the insulator 115 is installed to basically prevent heat transfer rather than to achieve a full adiabatic operation between the inner flow path 114a of the intermediate pipe 114 and the absorption catalysts 112, 113. In another embodiment of the present invention, an air gap may be formed between the intermediate pipe 114 and the absorption catalysts 112, 113 without the installation of the adiabatic member.

Namely, it is needed to delay the desorption of HC and NOₓ from the CCC absorption catalysts 112, 113 until the temperature of the UCC catalyst is increased to a higher degree after the UCC catalysts 122, 123 have warmed up. The insulator 115 or the air gap prevents the exhaust gas heat from the inner flow path 114a of the intermediate pipe from being transferred to the HC and NOₓ absorption catalysts 112, 113, so that the natural desorption of the absorbed HC and NOₓ by the heat is delayed.

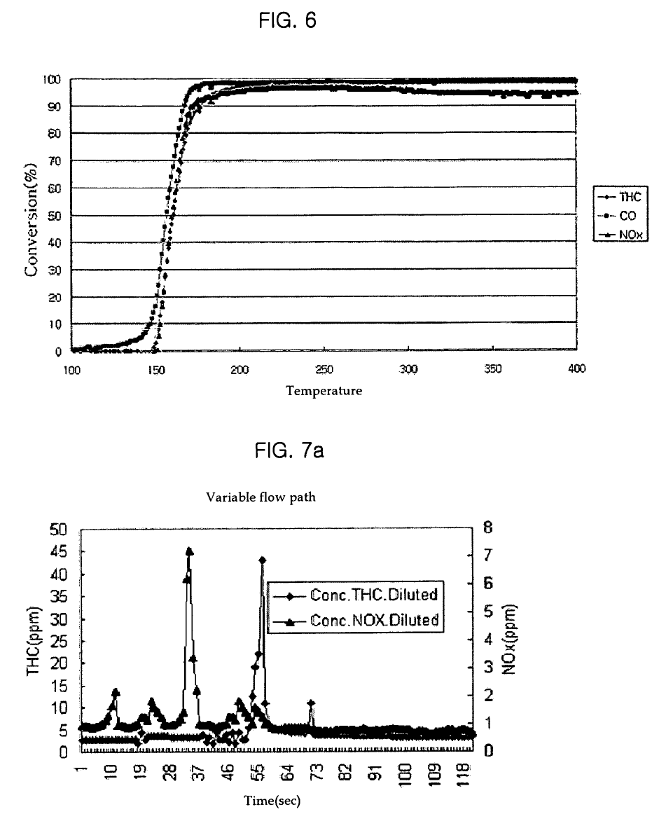

FIG. 6 is a graph of a catalyst activation (purification ratio) based on the temperature increase of a typical UCC catalyst. The purification ratio of all exhaust gases is nearly 100% at a temperature below 200° C. It is possible to effectively implement the present invention at 200° C., which can be a predetermined temperature used by the ECU to determine the warm-up state of the UCC catalyst.

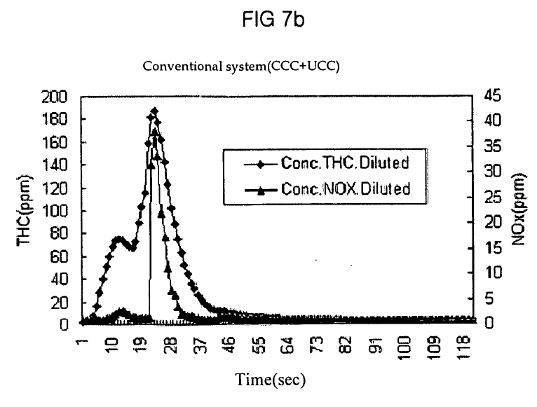

FIGS. 7a and 7b are graphs illustrating a result of a purification performance evaluation at 250° C. between the variable flow path type exhaust gas purification system used in the present invention and the typical “CCC+UCC” type exhaust gas purification system. In the purification system of the present invention, the purification performance was evaluated at 250° C. after the flow path was converted from the initial start time mode of the engine to its operation mode (90° position of ball valve). One-fifth of the exhaust gas was outputted during the initial start time of engine (FIG. 1) as compared to the conventional system. The SULEV reference for HC is 0.01 g/mile and for NOₓ is 0.02 g/mile.

As described above, in the system for purifying automobile exhaust gases according to the present invention, the CCC and UCC are installed, and the HC and NOₓ absorption catalysts, each having little or no precious metal carrying amount, are installed in the CCC. A variable flow path system including a bypass flow path and a flow path switching means is provided. At the initial start time of engine, the exhaust gas flows through the absorption catalyst in the CCC, and the absorption catalyst purifies the exhaust gas. Thereafter, during the warm-up state of the UCC catalyst, the flow path toward the absorption catalyst in the CCC becomes blocked, and the exhaust gas flows only toward the UCC catalyst, so that the exhaust gas can be purified by the UCC catalyst as normal. Therefore, the present invention enhances the purification performance. Since the HC and NOₓ absorption catalysts used in the CCC have little or no precious metals, the manufacturing cost is decreased. Since the CCC catalyst is used for a short time period during the initial start time of engine by using the variable flow path, no heat resistance and durability problems occur in the CCC catalyst.

While the foregoing description represent various embodiments of the present invention, it will be appreciated that the foregoing description should not be deemed limiting since additions, variations, modifications and substitutions may be made without departing from the spirit and scope of the present invention. It will be clear to one of skill in the art that the present invention may be embodied in other forms, structures, arrangements, and proportions and may use other elements, materials and components. For example, although the system is described in the context of purifying automobile exhaust gases, the system can be adapted for use in other types of motorized vehicles. The present disclosed embodiments are, therefore, to be considered in all respects as illustrative and not restrictive, the scope of the invention being indicated by the appended claims and not limited to the foregoing description.

1. A system for purifying automobile exhaust gases, comprising:
a Close Catalyst Converter installed near an engine exhaust manifold at an exhaust path and having a bypass flow path through which exhaust gases are directly discharged and not through a plurality of absorption catalysts, wherein said absorption catalysts are installed inside the Close Catalyst Converter;
an Underfloor Catalyst Converter installed on an exhaust pipe located at a lower side of an automobile body floor, the Underfloor Catalyst Converter being disposed downstream of the Close Catalyst Converter;
a temperature detection sensor to detect a temperature of a catalyst in the Underfloor Catalyst Converter;
an Electronic Control Unit receiving a signal from the temperature detection sensor, determining whether the catalyst in the Underfloor Catalyst Converter has reached a warm-up state by detecting whether said temperature exceeds a predetermined value, outputting a control signal for switching the exhaust path of the Close Catalyst Converter to the bypass flow path; and
a flow path switching means switching the exhaust path between a flow path on a side of the absorption catalysts in the Close Catalyst Converter and the bypass flow path in accordance with control signals of the Electronic Control Unit.

2. The system of claim 1, wherein the bypass flow path includes an intermediate pipe inserted into a plurality of holes formed at the absorption catalysts in a Close Catalyst Converter housing wherein an inlet and an outlet of the intermediate pipe are each positioned in an inlet path and an outlet path of the Close Catalyst Converter housing, respectively.

3. The system of claim 2 further including an insulator installed between an inner surface of a hole of the absorption catalysts and an outer surface of the intermediate pipe.

4. The system of claim 1, wherein said flow path switching means includes:
a motor installed in the Close Catalyst Converter housing or near an automobile body outside the Close Catalyst Converter inlet path and controlled by a control signal from the Electronic Control Unit; and
a valve rotated by a drive of the motor to switch the flow of the exhaust gas between two flow paths.

5. The system of claim 4, wherein said valve comprises a ball type valve and has a gas flow path wherein exhaust gas passes through.

6. The system of claim 4, wherein said valve installed at a front end entrance portion of the bypass flow path.

7. The system of claim 4, wherein the valve includes at least a concave part on at least one end of a gas flow path of the valve.

8. The system of claim 2, wherein said intermediate pipe includes a wing part formed at a front end entrance portion of the intermediate pipe.

9. The system of claim 1, wherein said absorption catalysts comprise HC absorption catalysts.

10. The system of claim 9, wherein said HC absorption catalysts comprise zeolite catalysts.

11. The system of claim 1, wherein said absorption catalysts comprise NOₓ absorption catalysts.

12. The system of claim 11, wherein said NOₓ absorption catalysts comprise potassium-based catalysts.

13. The system of claim 1, wherein said Underfloor Catalyst Converter comprises a first catalyst and a second catalyst.

14. The system of claim 13, wherein said first catalyst comprises a HC absorption catalyst and said second catalyst comprises a NOₓ absorption catalyst.

15. The system of claim 14, wherein said HC absorption catalyst comprises a zeolite catalyst and said NOₓ absorption catalyst comprises a potassium-based catalyst.
